(19) United States
(12) Patent Application Publication
(10) Pub. No.: US 2011/0030056 A1
(43) Pub. Date: Feb. 3, 2011

(54) INFORMATION PROCESSING APPARATUS

(76) Inventor: Shingo TOKUNAGA, Osaka (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/825,419

(22) Filed: Jun. 29, 2010

(30) Foreign Application Priority Data
Jul. 29, 2009 (JP) 2009-176391

(51) Int. Cl. G06F 21/06; G06F 1/32

(52) U.S. Cl. 726/23; 713/321

(57) ABSTRACT

Provided is an information processing apparatus capable of protecting against an unauthorized access from outside without increasing load of packet analysis and also capable of performing protection from a device inside a network. The information processing apparatus has a first network interface (illustrated using an NIC as an example) and is communicable with other information processing apparatus via the NIC. The information processing apparatus further has a second network interface (illustrated using an energy saving NIC as an example) for performing communication with other information processing apparatus in place of the NIC. The information processing apparatus executes switching processing for switching a network interface to be operated from the NIC to the energy saving NIC when an unauthorized access from outside is detected. At the time of the switching processing, internal information of the information processing apparatus is saved in the energy saving NIC.

### CROSS-NOTING PARAGRAPH

This non-provisional application claims priority under 35 U.S.C. §119(a) on Patent Application No. 2009-176391 filed in JAPAN on Jul. 29, 2009, the entire contents of which are hereby incorporated herein by reference.

### FIELD OF THE INVENTION

The present invention relates to an information processing apparatus, more specifically, to an information processing apparatus, such as a computer or an image forming apparatus, capable of being connected to other information processing apparatus via a network.

### BACKGROUND OF THE INVENTION

Conventional information processing apparatuses connectable to a network take measures against transmission of a large amount of packets such as a DoS (Denial of Service) attack and a network attack such as unauthorized intrusion by filtering unauthorized packets with a router or a firewall device and using a device for such measures only.

For example, Japanese Laid-Open Patent Publication No. 2003-110627 describes a means that a firewall and a network monitoring apparatus cooperate with each other to prevent an unauthorized access by blocking communication from an appropriate address against unauthorized intrusion into a public server in a DMZ (DeMilitarized Zone) which is an information management unit independent from a LAN (Local Area Network).

In the technology described in Japanese Laid-Open Patent Publication No. 2003-110627, however, since a network monitoring apparatus serving as a countermeasure device executes analysis for all received packets regardless of a packet whether which is received by an unauthorized access or by an appropriate access, load is increased and throughput of a network is reduced. Further, all communication on a path is affected by the countermeasure device. In particular, these problems become significant when a large amount of packets are transmitted, and system failure even occurs due to consumption of a large amount of resources.

In addition, in this technology, it is considered that protection by the countermeasure device such as a network monitoring device or a firewall device fails against communication from the inside of a network without passing through a barrier.

### SUMMARY OF THE INVENTION

The present invention has been made in view of the above circumstances and has an object to provide an information processing apparatus capable of protecting against an unauthorized access from outside without increasing load of packet analysis and also capable of performing protection from a device inside a network.

The first technical means of the present invention is an information processing apparatus having a first network interface, which is capable of communicating with other information processing apparatus via the first network interface, comprising: a second network interface for performing communication with other information processing apparatus in place of the first network interface, wherein switching processing for switching a network interface to be operated from the first network interface to the second network interface is executed when an unauthorized access from outside is detected, and at time of the switching processing, internal information of the information processing apparatus is saved in the second network interface.

The second technical means of the present invention is the information processing apparatus as defined in the first technical means, wherein the first network interface is operated when the information processing apparatus is in a normal power supply state, and the second network interface is operated when the information processing apparatus is in a power saving state.

The third technical means of the present invention is the information processing apparatus as defined in the second technical means, wherein the second network interface differentiates a response operation to an access from outside between a case where the information processing apparatus is in the power saving state and a case where the switching processing is performed due to the unauthorized access.

The forth technical means of the present invention is the information processing apparatus as defined in the first technical means, wherein the second network interface makes a response to a specific type of packet using the internal information saved at the time of the switching processing.

The fifth technical means of the present invention is the information processing apparatus as defined in the forth technical means, wherein the specific type of packet is a packet for requesting status information of the information processing apparatus.

The sixth technical means of the present invention is the information processing apparatus as defined in the first technical means, wherein the unauthorized access is an attack by transmitting a large amount of packets.

The seventh technical means of the present invention is the information processing apparatus as defined in the first technical means, wherein the unauthorized access is unauthorized intrusion from outside.

The eighth technical means of the present invention is the information processing apparatus as defined in the first technical means, wherein the first network interface and the second network interface have a common connection terminal or wireless connection portion for connecting to a network.

The ninth technical means of the present invention is the information processing apparatus as defined in the first technical means, wherein the information processing apparatus is a computer or an image forming apparatus.

### BRIEF DESCRIPTION OF THE DRAWINGS

FIG. 1 is a view showing a configuration example of an information processing apparatus according to the present invention;

FIG. 2 is a view showing a configuration example of a network system including the information processing apparatus of FIG. 1;

FIG. 3 is a flowchart for describing an example of switching processing in the information processing apparatus to which the present invention is applied included in the network system of FIG. 2; and

FIG. 4 is a flowchart for describing an example of receiving processing after the switching processing of FIG. 3.

### PREFERRED EMBODIMENTS OF THE INVENTION

An image forming apparatus as well as a computer such as a personal computer or a server computer is included as an information processing apparatus according to the present invention. Not only a printing device (printer), but also a multi-function peripheral provided with functions other than a print function, such as a copy function, an e-mail transmission function and a filing function, and the like is included as the image forming apparatus. This also applies to other information processing apparatuses performing communication with the information processing apparatus according to the present invention.

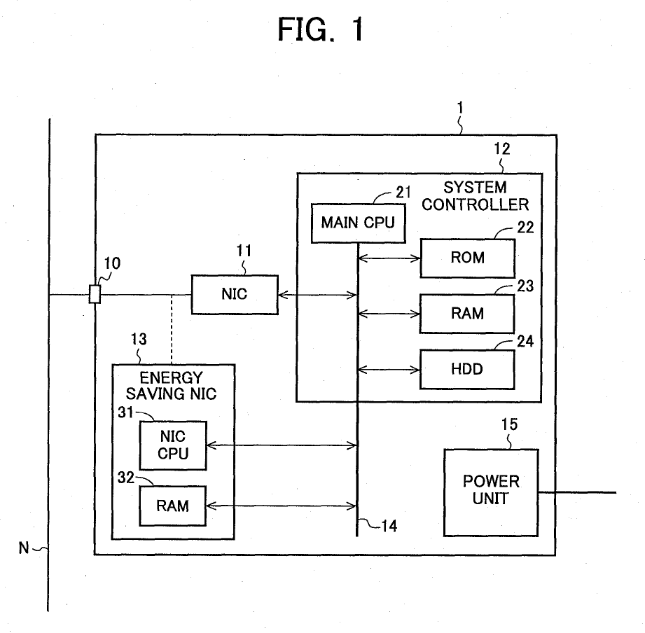

FIG. 1 is a view showing a configuration example of the information processing apparatus according to the present invention. An information processing apparatus 1 illustrated in FIG. 1 is provided with an NIC (Network Interface Card) 11 and a LAN terminal 10 as an example of a first network interface, and further provided with a system controller 12. The LAN terminal 10 is a terminal for inserting a LAN cable and is connected to the NIC 11. The information processing apparatus 1 is connected to a network N via the NIC 11 and the LAN terminal 10, is communicable with other information processing apparatus, and can be called a network connection device.

Data transfer between portion inside the information processing apparatus 1 is performed via a system bus 14. Moreover, power supply to each portion is performed through power cable (not-shown) from a power unit 15 to which an external power cable is connected.

The system controller 12 has a control portion comprised of a main CPU (Central Processing Unit) 21 serving as a computing apparatus, a ROM (Read Only Memory) 22 having a control program executed by the main CPU 21 stored therein, a RAM (Random Access Memory) 23 serving as a working memory at the time of executing the program, and the like to perform control of the entire information processing apparatus 1, including control of the NIC 11. For example, when the information processing apparatus 1 is a computer such as a PC, an OS (Operating System) is also included in the control program. In addition, the system controller 12 is provided with a storage apparatus. An HDD (Hard Disc Drive) 24 is illustrated as the storage apparatus here, but other nonvolatile memory is possible.

Further, the information processing apparatus 1 is provided with a second network interface for performing communication with other information processing apparatus in place of the first network interface illustrated using the NIC 11 as an example. That is, the information processing apparatus 1 is provided with two network interfaces, namely, the first and second network interfaces. The case where the second network interface is operated in place of the first network interface is when an unauthorized access from outside is detected as described below.

In FIG. 1, an energy saving NIC 13 and the LAN terminal 10 are provided as an example of the second network interface. While the NIC 11 is operated when a main body of the information processing apparatus 1 is in a normal power supply state (normal stand-by state or normal operational state), the energy saving NIC 13 is operated when the main body of the information processing apparatus 1 is in a power saving state (electricity saving state). Accordingly, when the main body of the information processing apparatus 1 is shifted from the normal power supply state to the power saving state, that is, from a normal mode to a power saving mode, the energy saving NIC 13 is responsible for network processing in place of the NIC 11 to perform a communication operation.

The energy saving NIC 13 has an NIC CPU (hereinafter referred to as a CPU inside the energy saving NIC) 31 and an NIC RAM (hereinafter referred to as a RAM inside the energy saving NIC) 32, and is capable of performing control independent from the system controller 12 (main CPU 21) and the NIC 11, and operates with less power and resource independent from the side of the system controller 12 and the NIC 11. Note that, a nonvolatile memory or the like may be used in place of the RAM inside the energy saving NIC, and in the case of the nonvolatile memory, it is only necessary to delete the data when stored data becomes unnecessary.

It is configured such that, with respect to received packets, the NIC 11 analyzes all the packets so as not to respond to packets of an unauthorized access, while the energy saving NIC 13 responds only to a predetermined type of packets, thus making it possible to basically reduce processing itself in the energy saving NIC 13 compared to the NIC 11. Note that, as another method, by configuring such that the NIC 11 also responds only to a predetermined type of packets and reducing the number of types of packets to be responded in the energy saving NIC 13, it is also possible that frequency of responding by the energy saving NIC 13 is less than that of responding by the NIC 11.

Note that, the second network interface is illustrated using the energy saving NIC 13 (and the LAN terminal 10) as an example, but is not always necessary to be used as a network interface provided for the power saving state and may be provided to be operated as a substitution of the first network interface illustrated using the NIC 11 as an example when an unauthorized access from outside is detected as described below.

In addition, it is preferable that, as illustrated using the LAN terminal 10 as an example, the first network interface and the second network interface have a common connection terminal for connecting to the network. Moreover, it may be configured so that a common wireless connection portion may be provided in place of the connection terminal.

As a main feature of the present invention, the information processing apparatus 1, when detecting an unauthorized access from outside (network attack), executes switching processing for switching the network interface to be operated from the NIC 11 to the energy saving NIC 13. For the detection, the information processing apparatus 1 is provided with a detection portion for performing detection of the unauthorized access. The detection portion may be mounted in the ROM 22 or the HDD 24 as a detection program so as to be executable by the main CPU 21 in conjunction with the NIC 11. Note that, the detection portion may be mounted as a hardware such as by being provided in the NIC 11 so as to transmit a detection result to the system controller 12. Moreover, the unauthorized access from outside may be defined as an attack by transmitting a large amount of packets or unauthorized intrusion from outside. The processing itself for detecting the unauthorized access may use a known technology.

In addition, the information processing apparatus 1, when shifting from the normal operation to the power saving operation, saves data on the RAM 23 into the HDD 24 regardless of whether or not triggered by detection of the unauthorized access. Further, if there is information needed for the response at the time of the power saving operation in the data on the RAM 32, the information is also transferred to the RAM inside the energy saving NIC 32. When saving of the data is completed, network processing is performed by the energy saving NIC 13 shifted from the NIC 11 and the system controller 12. In addition, the power unit 15 stops or largely reduces power supply to each portion of the system controller 12.

In this manner, in the switching processing, the information processing apparatus 1 stores internal information of the information processing apparatus 1 in the energy saving NIC 13 to allow communication in the energy saving NIC 13. The switching processing including the storing processing may be performed by control of the main CPU 21 upon detection of the unauthorized access. Here, the internal information indicates information needed for communication at the time of the power saving operation. The internal information is information on the RAM 23 as described above, information stored in the ROM 22 or the HDD 24 etc., or information stored in a memory inside the NIC 11. An example of the internal information includes information of a device needed to generate a packet to be transmitted in the response at the time of the power saving operation, for example, such as an IP address or status information of the information processing apparatus 1.

As described above, the information processing apparatus 1, when detecting some unauthorized access from outside at the time of the normal operation, switches from the NIC 11 that usually operates to the energy saving NIC 13 that originally operates when the information processing apparatus 1 is in the power saving state.

Since then, the information processing apparatus 1 responds to an access from outside by the energy saving NIC 13 regardless of an unauthorized access or an appropriate access.

In this manner, in the information processing apparatus of the present invention, first, detection of an unauthorized access is performed, and when no unauthorized access is detected, the NIC 11 is kept operating to perform packet analysis for the response with respect to an appropriate access, while when the unauthorized access is detected, it is switched so that the energy saving NIC 13 is operated to continuously perform packet analysis for packets with possibility of an unauthorized access. That is, in the information processing apparatus 1 of the present invention, for the packet after the unauthorized access is detected, the NIC 11 or the system controller 12 does not need to perform packet analysis and processing based on the result thereof and resources thereof are not consumed in a large amount, and much less processing is just performed by the energy saving NIC 13, thus making it possible to reduce load on the packet analysis compared to its conventional counterpart. Moreover, it is not to say that in the information processing apparatus 1, all communication to a subnetwork under a barrier such as a firewall device is affected, it is also possible to reduce degree of the reduction in throughput of the network compared to its conventional counterpart.

Accordingly, in the information processing apparatus 1 of the present invention, even when a large amount of packets are transmitted, it is possible to prevent the occurrence of the system failure and to protect data of the information processing apparatus 1 in operation at the time of detection. Further, in the information processing apparatus 1 of the present invention, it is possible to block access authentication even against unauthorized intrusion from outside by switching to operate the energy saving NIC 13, thus making it possible to save data and the like even against the unauthorized intrusion from outside. In addition, such effect in the information processing apparatus 1 enables to reduce even influence on all communication on a path when an unauthorized access is made.

Further, it possible that in the information processing apparatus 1 of the present invention, prevent the unauthorized access even for communication from the inside of the network without using a barrier because the information processing apparatus 1 itself has an unauthorized access prevention function and, performs protection by itself by switching to operate the energy saving NIC 13 even when it is a network attack.

In this manner, according to the information processing apparatus of the present invention, it is possible to perform protection against an unauthorized access from outside without increasing load of packet analysis and to also perform protection from a device inside the network.

Next, description will be given for the operation of the energy saving NIC 13 after the switching processing. It is preferable that the energy saving NIC 13, when switched from the NIC 11 upon detection of an attack or the like as described above, respond only to a predetermined specific type of packet as described above. This makes it possible to protect against an unauthorized access and to respond to a request from a service center or the like. Here, an example of the specific type of packet includes a status information request packet by an SNMP (Simple Network Management Protocol) polling or the like. In responding to the request, the internal information saved at the time of the switching processing is used.

In this manner, it is preferable that the energy saving NIC 13 makes a response to the specific type of packet using the internal information saved at the time of the switching processing. Responding only to the specific type of packet enables to reduce even load on the energy saving NIC 13 itself and to respond only to a packet which must be responded at the least.

Note that, even when no unauthorized access is detected and the energy saving NIC 13 is operated only for power saving, the energy saving NIC 13 may make a response only to the above-described specific type of packet with respect to received packets.

In this case, however, it may be configured to respond to wider types of packet with respect to received packets, compared to the case where the unauthorized access is detected and the energy saving NIC 13 is operated. In this manner, it is preferable that the energy saving NIC 13 differentiate the operation for responding to an access from outside between the case where the information processing apparatus 1 is in the power saving state and the case where the switching processing is performed due to the unauthorized access.

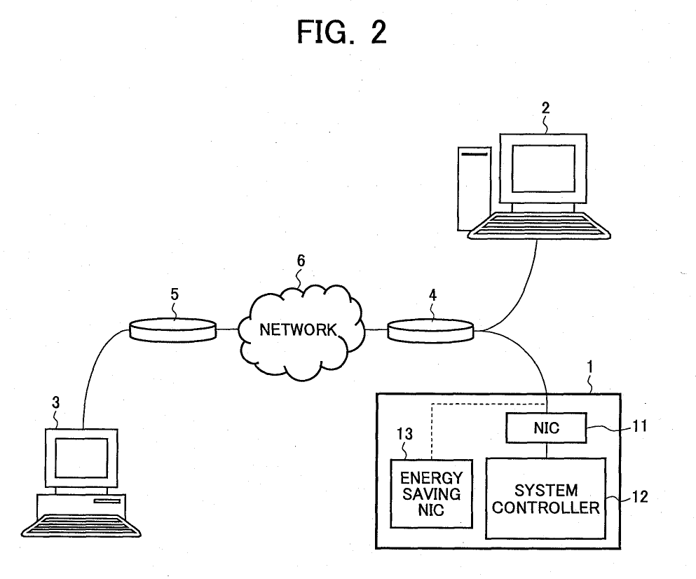

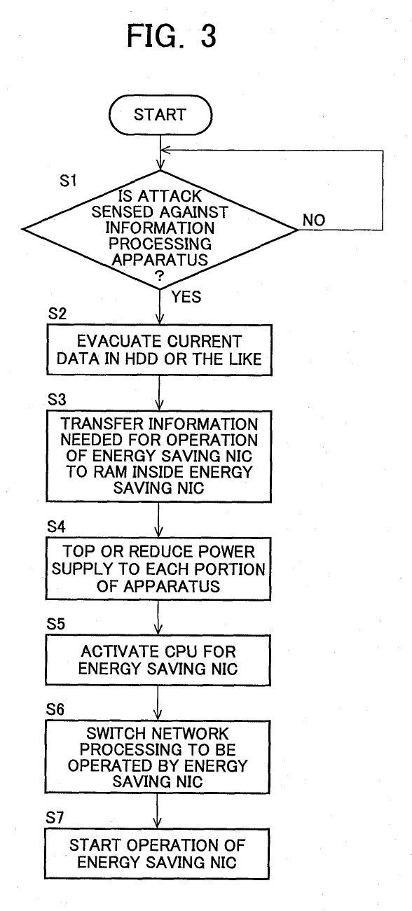

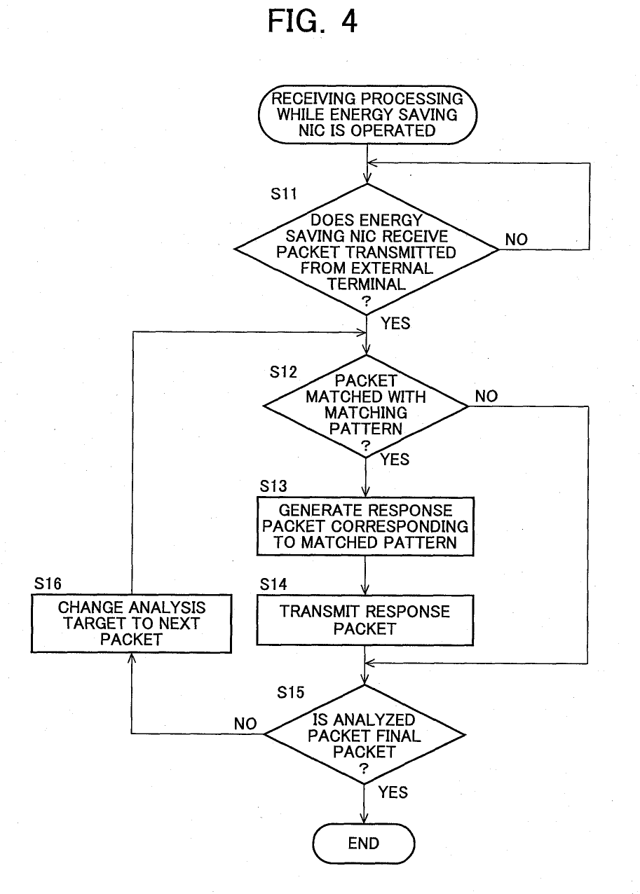

Next, description will be given for a preferred processing example in the information processing apparatus 1 described above with reference to FIGS. 2 to 4. FIG. 2 is a view showing a configuration example of a network system including the information processing apparatus of FIG. 1. Further, FIG. 3 is a flowchart for describing an example of switching processing in the information processing apparatus to which the present invention is applied included in the network system of FIG. 2 and FIG. 4 is a flowchart for describing an example of receiving processing after the switching processing of FIG. 3.

In the network system illustrated in FIG. 2, the above-described information processing apparatus 1, a client terminal 2 as an example of other information processing apparatus, and an attacker terminal 3 are connected through a network 6. Here, the information processing apparatus 1 and the client terminal 2 belong to a network comprised of a router 4 and the attacker terminal 3 belongs to a network comprised of a router 5. In addition, the router 4 and the router 5 are connected via the network 6.

Description will be given with reference to FIG. 3 for processing for shifting from detection of a network attack to operation of the energy saving NIC 13 in such a network system.

The information processing apparatus 1 detects an unauthorized access such as a DoS attack or unauthorized intrusion, namely, a network attack, by packet analysis with respect to packets received by the NIC 11 (step S1). As a detection (sensing) method thereof, a known method may be used. For example, detection is performed by matching a bit pattern of a TCP/IP (Transmission Control Protocol/Internet Protocol) header that is characteristic of packets used for a DoS attack with transmitted packets. As to the unauthorized intrusion, by counting the number of times of authentication failure for the information processing apparatus 1, password searching by a brute force attack or the like by an attacker is detected.

When the network attack is sensed (in the case of YES at step S1), the main CPU 21 of the information processing apparatus 1 transfers internal information to a nonvolatile storage apparatus such as the HDD 24 and save data (step S2).

Then, in preparation for a communication operation in the energy saving NIC 13, the main CPU 21 transfers information needed for the communication operation to the RAM inside the energy saving NIC 32 (step S3). The main CPU 21 then stops or reduces power supply to each portion of the information processing apparatus 1 (step S4). Further, the main CPU 21 activates the CPU inside the energy saving NIC 31. If necessary, information stored in the RAM inside the energy saving NIC 32 at step S2 is used for the activation (step S5). Here, of course, power supply to the energy saving NIC is performed.

Then, the main CPU 21 switches from the NIC 11 to the energy saving NIC 13 for network processing (step S6). At this time, the main CPU 21 may cut out or reduce its own power supply. Through steps S2 to S6 described above, the operation of the energy saving NIC 13 is started (step S7) and shifting to the operation by the energy saving NIC is completed.

Note that, regarding steps S2 to S6 described above, the order of processing can be changed, if possible. However, information saving/transfer processing (steps S2 and S3) needs to be performed before power supply stopping/reducing processing (step S4) in order to hold information on a volatile memory. In addition, when power supply to the main CPU 21 is cut out, the cut-out processing is executed at least after processing of steps S2 to S6 described above.

Description will be given with reference to FIG. 4 for the processing in which the energy saving NIC 13 receives packets from outside after the switching processing has been performed in this manner.

First, the energy saving NIC 13 of the information processing apparatus 1 waits for a packet transmitted from an external terminal (other information processing apparatus) (step S11). When the transmitted packet is received (in the case of YES at step S11), the energy saving NIC 13 performs pattern matching for the received packet (step S12). At this time, when matching to a pattern that has been registered in advance in an internal nonvolatile memory or the like is satisfied, a response packet of the corresponding pattern is generated (step S13) and the generated response packet is transmitted (step S14).

After transmission of the packet is completed, the energy saving NIC 13 judges whether or not the corresponding packet is the final packet of received packets (step S15), and in the case of the final packet, processing is completed. In the case of not the final packet, a next packet is changed to an analysis packet (step S16) and the flow returns to step S12 to perform pattern matching of the packet again. Alternatively, in the case of NO at step S12, the flow directly goes to step S15, where the received packet may be discarded.

In the processing procedure described in FIG. 4, when the external terminal is the client terminal 2 of FIG. 2 and requests acquirement of the status of the information processing apparatus 1, the pattern matching is obtained at step S12 and the status information can be transmitted to the client terminal 2 through steps S13 and S14. Thereby, the client terminal 2 is able to acquire the status information of the information processing apparatus 1.

On the other hand, when the external terminal is the attacker terminal 3 of FIG. 2 and request a DoS attack or unauthorized intrusion to the information processing apparatus 1, the unauthorized access is detected due to the unsatisfaction of the pattern matching at step S12, and therefore, resulting that the attacker terminal 3 can not acquire the packet response because the flow does not pass through steps S13 and S14 and packet generation processing does not occur on the side of the information processing apparatus 1 and packet transmission is also not performed. At this time, it is preferable to informed an administrator of the detection of the unauthorized access or to save a detection history.

Here, description will be given for returning after shifting so that the energy saving NIC 13 is operated upon detection of the unauthorized access as described in FIG. 4. Examples of the case of returning to operate the NIC 11 include (A1) the case of returning by a direct operation of a user such as by pressing a switch after an administrator has taken measures or the like and (A2) the case of returning by a previous setting such as a timer setting in preparation for the case where the administrator is absent. Since there is a possibility that packet transmission by an attacker continues for a fixed time and a possibility that the attack is given again even after returning, it is preferable not to allow returning in the case other than the cases of (A1) and (A2) described above.

Further, even when shifted to the power saving operation only for power saving regardless of detection of an unauthorized access, since the power saving operation has no point as long as returning is performed by the packet response one by one, it is preferable that returning is basically not performed except for the following cases. The cases of allowing returning include (B1) the case of returning by a direct operation of a user such as by pressing a switch, (B2) the case of returning by a previous setting such as a timer setting, and (B3) the case where a specific packet prescribed as the returning condition (e.g. a packet including printing instruction) is received.

Although description has been given above assuming that detection of an unauthorized access is activated when the energy saving NIC 13 is not operated, it is preferable that detection of an unauthorized access is also performed when the energy saving NIC 13 is already operated in the power saving state. For example, the energy saving NIC 13, even in the power saving state, may execute the processing of FIG. 4 including the pattern matching at step S12 as a kind of the unauthorized access detection processing.

In addition, in the embodiment in which an unauthorized access is detected even in the power saving state, when a different response operation is performed from that in the case where the energy saving NIC 13 is activated by the switching processing described above, the matching pattern of the matching at step S12 may be differentiated (for example, patterns to be matched as described above is reduced more, that is, types of packets to be responded is reduced in the case where the energy saving NIC 13 is activated by the switching processing).

1. An information processing apparatus having a first network interface, which is capable of communicating with other information processing apparatus via the first network interface, comprising:
a second network interface for performing communication with other information processing apparatus in place of the first network interface, wherein
switching processing for switching a network interface to be operated from the first network interface to the second network interface is executed when an unauthorized access from outside is detected, and at time of the switching processing, internal information of the information processing apparatus is saved in the second network interface.

2. The information processing apparatus as defined in claim 1, wherein
the first network interface is operated when the information processing apparatus is in a normal power supply state, and the second network interface is operated when the information processing apparatus is in a power saving state.

3. The information processing apparatus as defined in claim 2, wherein
the second network interface differentiates a response operation to an access from outside between a case where the information processing apparatus is in the power saving state and a case where the switching processing is performed due to the unauthorized access.

4. The information processing apparatus as defined in claim 1, wherein
the second network interface makes a response to a specific type of packet using the internal information saved at the time of the switching processing.

5. The information processing apparatus as defined in claim 4, wherein
the specific type of packet is a packet for requesting status information of the information processing apparatus.

6. The information processing apparatus as defined in claim 1, wherein
the unauthorized access is an attack by transmitting a large amount of packets.

7. The information processing apparatus as defined in claim 1, wherein
the unauthorized access is unauthorized intrusion from outside.

8. The information processing apparatus as defined in claim 1, wherein
the first network interface and the second network interface have a common connection terminal or wireless connection portion for connecting to a network.

9. The information processing apparatus as defined in claim 1, wherein
the information processing apparatus is a computer or an image forming apparatus.
